(19) United States
(12) Patent Application Publication
(10) Pub. No.: US 2005/0176509 A1
(43) Pub. Date: Aug. 11, 2005

(54) Cabinet, information terminal device and gaming machine using thereof

(75) Inventor: Jun Hirato, Tokyo (JP)

Correspondence Address: MCGINN & GIBB, PLLC, 8321 OLD COURTHOUSE ROAD, SUITE 200, VIENNA, VA, 22182-3817, US

(73) Assignee: Aruze Corp., Tokyo (JP)

(21) Appl. No.: 11/052,248

(22) Filed: Feb. 8, 2005

(30) Foreign Application Priority Data
Feb. 9, 2004 (JP) 2004-032589

(51) Int. Cl. G06F 17/00

(52) U.S. Cl. 463/46

(57) ABSTRACT

The cabinet 1 for the information terminal device 41 and the gaming machine 42 which are installed on the floor or the stand and used is constructed from the ceiling portion 2 which is arranged at the upper position of the liquid crystal display device 10 and has the measure corresponding to the width of the liquid crystal display device 10, the left and right side plate portions 3, 4 which are arranged at both the left and right sides of the liquid crystal display device 10 and each of which has the uniform width corresponding to the depth of the liquid crystal display device 10 over entire length thereof and the length regulated corresponding to the height of the information terminal device 41 or the gaming machine 42 except for the liquid crystal display device 10, the bottom portion 5 capable of contacting with the floor or the stand and the rear panel 6 which is arranged between the ceiling portion 2 and the bottom portion 5 and can separately install the information process device 31 and the power unit 32 so that both the information process device 31 and the power unit 32 does not superimpose with each other in the front-and-rear direction.

### CROSS-REFERENCE TO THE RELATED APPLICATION (S)

This application is based upon and claims a priority from the prior Japanese Patent Application No. 2004-032589 filed on Feb. 9, 2004, the entire contents of which are incorporated herein by reference.

### BACKGROUND OF THE INVENTION

1. Field of the Invention

The present invention relates to a cabinet of thin type with a short depth, capable of utilizing for an information terminal device which is installed on a floor or a predetermined stand and used in a convenience store or for a gaming machine in a game arcade, and relates to an information terminal device and a gaming machine using thereof.

2. Description of Related Art

Conventionally, in a convenience store, it is installed on a floor or a predetermined stand an information terminal device through which a customer can buy commodities, various tickets, admission tickets for leisure facilities and pay various money and conduct reservation of facilities for stay. This kind of information terminal device, has a construction that a liquid display device, an information process device for controlling transmission and input-output of information, a power unit for supplying electric power are assembled in a cabinet installed on the floor.

On the other hand, as a gaming machine in the game arcade, there exists a gaming machine which is installed in the game arcade and used therein. This kind of the gaming machine has a construction that a plurality of mechanical reels for conducting variable display of images, a liquid crystal display device, an information process device, a power unit for supplying electric power are assembled in a cabinet installed on the floor or a predetermined stand.

As mentioned, each of the information terminal device and the gaming machine installed on the floor or the predetermined stand has the cabinet in which constructive elements necessary therefore are assembled.

And this cabinet has a bottom plate portion, a ceiling plate portion, a pair of left and right side plate portions and a rear plate portion, and has a substantially parallelepiped shape. For example, such cabinet for the gaming machine is constructed by integrally forming it from metallic material such as aluminum, wood material or resin material, or by assembling the above plate portions. For example, in Japanese Patent publication no. 2003-205065, it is disclosed a cabinet for the gaming machine which is integrally formed by casting it from light metal material such as aluminum.

Here, in order to easily and rapidly produce such cabinet with a low cost, it is desirable that measure thereof is made common.

However, in a case that the information terminal device or the gaming machine installed on the floor or the predetermined stand is installed in the convenience store or the game arcade, it is necessary to take a situation of install place into consideration. That is to say, when this kind of the information terminal device or the gaming machine is installed, there will occur various demands such that it is desirable to fit for measure of the stand existing in the install place or a rack existing in a circumference of the stand (for example, it is desirable to make height and depth thereof as same as those of the information terminal device or the gaming machine), that it is desirable to miniaturize height and depth of the cabinet as small as possible so as to be able to install in a limited space, or that it is desirable to set measure thereof so that children can use. Therefore, measure of the cabinet inevitable for the information terminal device or the gaming machine has to be determined according to above demands (needs).

And in the information terminal device and the gaming machine, in addition that there exist constructive elements such as the liquid crystal display device and the power unit which can be commonly utilized, there exist devices characteristic of each of them. For example, a card reader and an issuing device are characteristic of the information terminal device, and on the contrary, mechanical reels are characteristic of the gaming machine. In a case of the latter, since each device does not have a constant measure in height and depth thereof, it is desirable to individually prepare a cabinet with different measure so as to fit to each characteristic constructive element.

However, in order to individually prepare the cabinet fitting to demands and use in the install place, concerning with each of the plate portions constructing the cabinet, it is necessary to individually prepare metal mold for producing each of the plate portions, to individually prepare each of the plate portions with mutually different measures by utilizing each metal mold and to assemble each of the plate portions and to individually produce the cabinet. Therefore, in a case that the cabinet is individually prepared corresponding to each of install places, there exist problems that it takes a long time to produce the cabinet and a cost thereof becomes high.

### SUMMARY OF THE INVENTION

The present invention has been done to dissolve the above problems and has an object to provide a cabinet, an information terminal device and a gaming machine using the cabinet with a general purpose fitting to demands and use in each of the install places, the cabinet capable of being easily and rapidly produced with a low cost.

In order to dissolve the above problems, according to one aspect of the present invention, it is provided a cabinet for an information terminal device and a gaming machine, each of the information terminal device and the gaming machine having a liquid crystal display device,
the cabinet comprising:
a ceiling portion disposed on the liquid crystal display device, the ceiling portion having a width corresponding to a width of the liquid crystal display device;
a pair of side plate portions arranged at both sides of the liquid crystal display device, each of the side plate portions having a uniform width corresponding to a depth of the liquid crystal display device and a length longer than a height of the liquid crystal device and regulated corresponding to a height of the information terminal device or the gaming machine except for the liquid crystal display device;
a bottom portion; and
a rear panel with a width corresponding to the width of the ceiling portion, the rear panel being arranged between the ceiling portion and the bottom portion and capable of separately containing an information process device and a power unit both of which are commonly utilizable for the information terminal device and the gaming machine.

In the above cabinet, the length of the pair of side plate portions, which determine the height of the cabinet, is regulated corresponding to the height of the information terminal device and the gaming machine, thereby the cabinet can be utilized for production of the information terminal device and the gaming machine and has high degree of freedom in the height thereof. And since the cabinet has the thickness corresponding to the depth of the liquid crystal display device, the cabinet can be made thin.

And according to another aspect of the present invention, it is provided an information terminal device with a cabinet capable of producing an information terminal device having a liquid crystal display device,
wherein the cabinet comprising:
a ceiling portion disposed on the liquid crystal display device, the ceiling portion having a width corresponding to a width of the liquid crystal display device;
a pair of side plate portions arranged at both sides of the liquid crystal display device, each of the side plate portions having a uniform width corresponding to a depth of the liquid crystal display device and a length longer than a height of the liquid crystal device and regulated corresponding to a height of the information terminal device or the gaming machine except for the liquid crystal display device;
a bottom portion; and
a rear panel with a width corresponding to the width of the ceiling portion, the rear panel being arranged between the ceiling portion and the bottom portion and capable of separately containing an information process device and a power unit both of which are utilized in the information terminal device;
wherein a thin space is formed by the ceiling portion, the bottom portion, the side plate portions and the rear panel,
wherein the liquid crystal display device utilized in the information terminal device is assembled in the thin space,
wherein the information process device and the power unit are received on the rear panel, and
wherein electric power is supplied to the liquid crystal display device and the information process device from the power unit and the liquid crystal display device displays images thereon according to control of the information process device.

In the cabinet of the information terminal device, the length of the pair of side plate portions, which determine the height of the cabinet, is regulated corresponding to the height of the information terminal device, thereby the cabinet can be utilized for production of the information terminal device and has high degree of freedom in the height thereof. And since the cabinet has the thickness corresponding to the depth of the liquid crystal display device, the cabinet can be made thin.

And according to further another aspect of the present invention, it is provided a gaming machine with a cabinet capable of producing a gaming machine having a liquid crystal display device,
wherein the cabinet comprising:
a ceiling portion disposed on the liquid crystal display device, the ceiling portion having a width corresponding to a width of the liquid crystal display device;
a pair of side plate portions arranged at both sides of the liquid crystal display device, each of the side plate portions having a uniform width corresponding to a depth of the liquid crystal display device and a length longer than a height of the liquid crystal device and regulated corresponding to a height of the information terminal device or the gaming machine except for the liquid crystal display device;
a bottom portion; and
a rear panel with a width corresponding to the width of the ceiling portion, the rear panel being arranged between the ceiling portion and the bottom portion and capable of separately containing an information process device and a power unit both of which are utilized in the gaming machine;
wherein a thin space is formed by the ceiling portion, the bottom portion, the side plate portions and the rear panel,
wherein the liquid crystal display device utilized in the gaming machine is assembled in the thin space,
wherein the information process device and the power unit are received on the rear panel, and
wherein electric power is supplied to the information process device and the liquid crystal display device from the power unit and a game is conducted by using images displayed on the liquid crystal display device which is controlled through the information process device.

In the cabinet of the gaming machine, the length of the pair of side plate portions, which determine the height of the cabinet, is regulated corresponding to the height of the gaming machine, thereby the cabinet can be utilized for production of the gaming machine and has high degree of freedom in the height thereof. And since the cabinet has the thickness corresponding to the depth of the liquid crystal display device, the cabinet can be made thin.

As mentioned, according to the present invention, it can be provided a cabinet which has general purpose adoptable for demand and use necessary for install places and can be easily and rapidly produced with a low cost, the information terminal device and the gaming machine utilizing the cabinet.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a perspective view schematically showing a whole construction of a cabinet according to the embodiment of the present invention,

FIG. 2 is a right side view of the cabinet according to the embodiment,

FIG. 3 is a rear view of the cabinet according to the embodiment,

FIG. 4 is a perspective view of the cabinet in which a right plate portion is partially removed,

FIG. 5 is a sectional view of the cabinet sectioned along 5-5 line shown in FIG. 1,

FIG. 6 is a sectional view of the cabinet sectioned along 6-6 line shown in FIG. 1,

FIG. 7 is a perspective view of an information terminal device in which the cabinet is utilized,

FIG. 8 is a front view of a gaming machine in which the cabinet is utilized,

FIG. 9 is a perspective view showing a state that a plurality of the gaming machines, in each of which the cabinet is utilized, are installed in a game arcade,

FIG. 10 is a block diagram showing an inner electrical construction of the information terminal device in which the cabinet is utilized, and

FIG. 11 is a block diagram showing an inner electrical construction of the gaming machine in which the cabinet is utilized.

### DETAILED DESCRIPTION OF THE PREFERRED EMBODIMENTS

Hereinafter, the embodiment of the present invention will be described. Here, the same number is utilized for the same element and explanation thereof will not be repeatedly done.

(Explanation of the Cabinet)

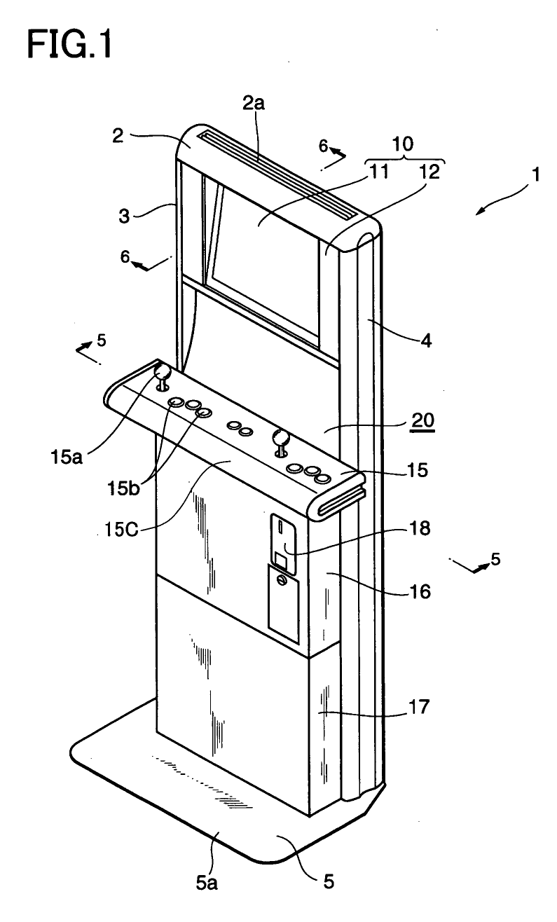

At first, with reference to FIGS. 1˜6, the cabinet according to the present invention will described.

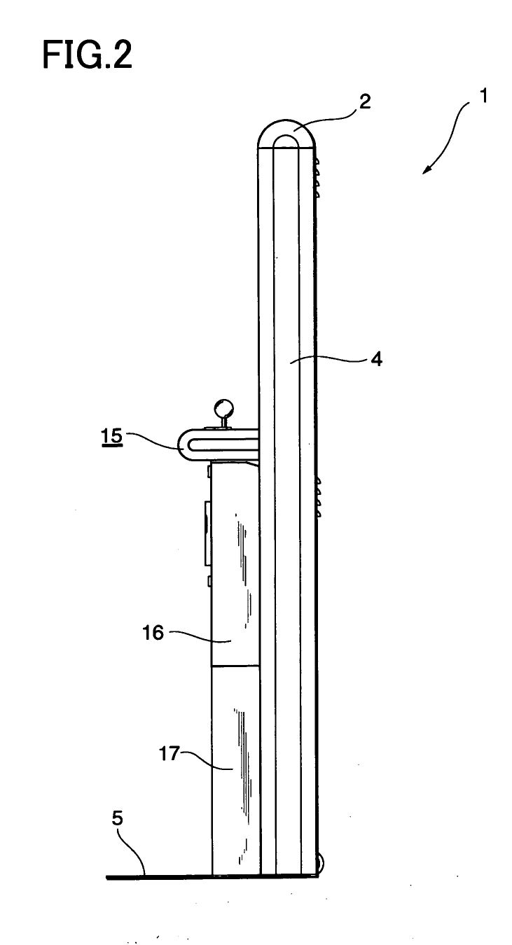

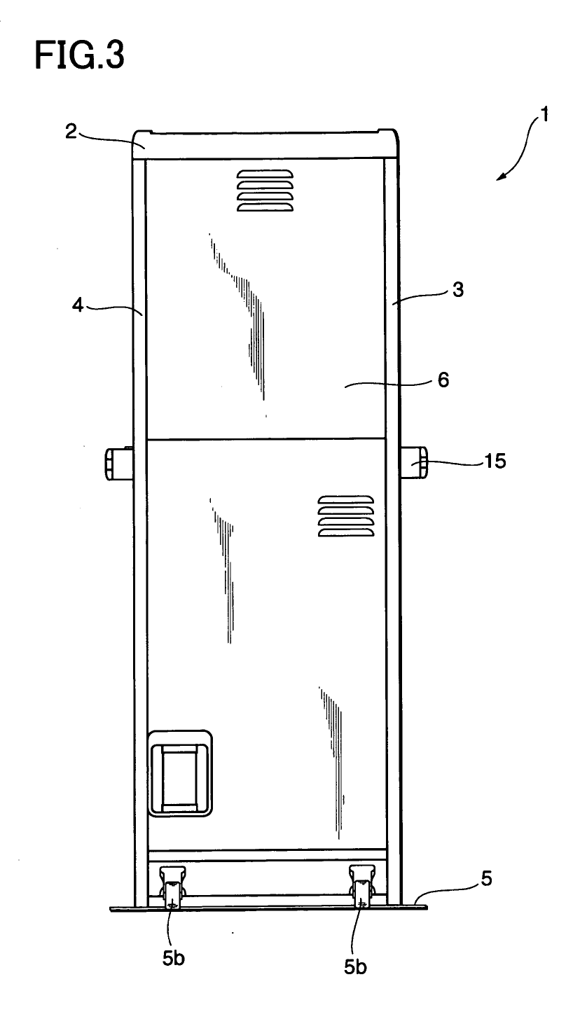

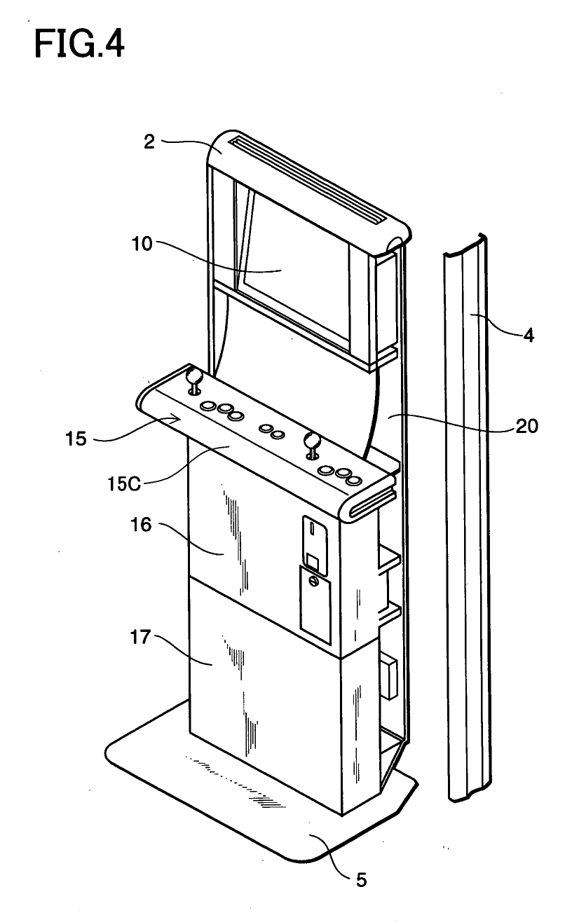

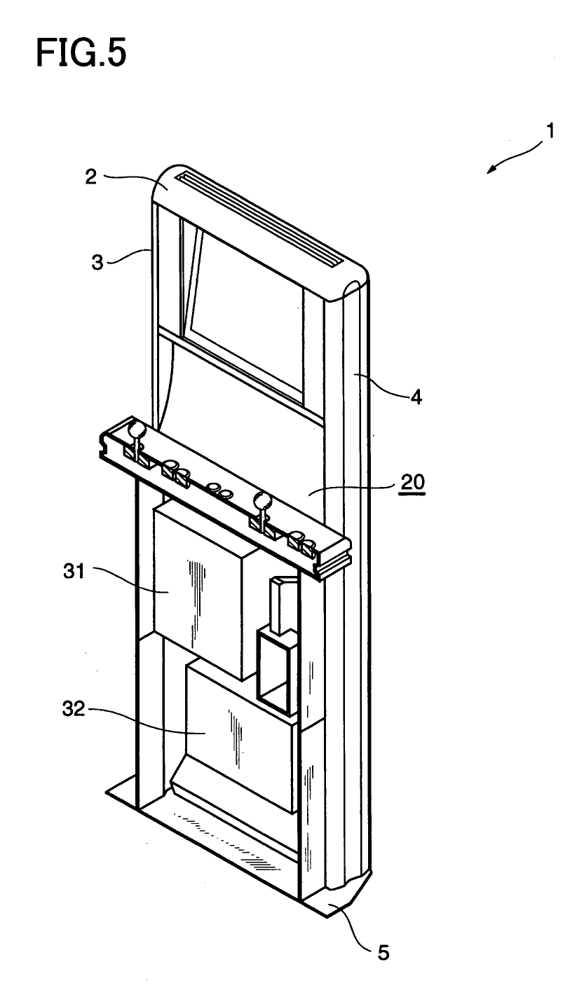

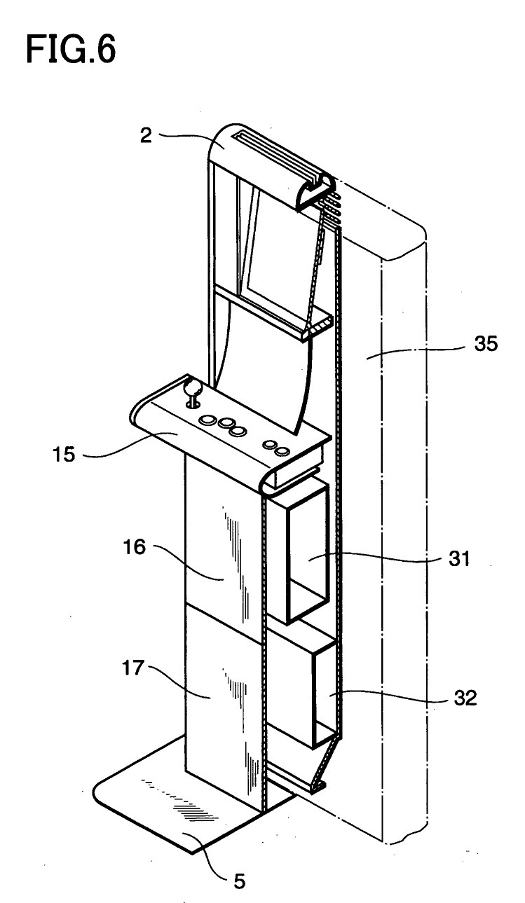

Here, FIG. 1 is a perspective view showing a whole construction of the cabinet 1 according to the embodiment of the present invention. FIG. 2 is a right side view of the cabinet according to the embodiment, FIG. 3 is a rear view of the cabinet according to the embodiment, FIG. 4 is a perspective view of the cabinet in which a right plate portion is partially removed, FIG. 5 is a sectional view of the cabinet sectioned along 5-5 line shown in FIG. 1, and FIG. 6 is a sectional view of the cabinet sectioned along 6-6 line shown in FIG. 1.

The cabinet 1 has a construction through which it can be produced an information terminal device installed on the floor in a convenience store and utilized therein and a gaming machine (for example, a gaming machine in a game arcade) of a built-in type, the gaming machine being installed on the floor or a predetermined stand in the game arcade and utilized therein. This cabinet 1 is constructed so that a liquid crystal display device 10, which is commonly utilized in both the information terminal device and the gaming machine, can be assembled. In FIG. 1, it is shown a state that the liquid crystal device 10 is already assembled.

And the cabinet 1 has a ceiling portion 2, a left side plate portion 3, a right side plate portion 4, a bottom portion 5 and a rear panel 6.

The ceiling portion 2 is arranged at an upper side of the liquid crystal display device 10 assembled in the cabinet 1. The ceiling portion 2 is made of resin or metal and has measure (a width and a depth) corresponding to a width and a depth of the liquid crystal display device 10. As shown, this ceiling portion 2 is curved so that a center portion thereof in a direction of the depth (direction of a front-and-rear direction) projects and a POS stand 2a formed in a plurality of grooves extending along a width direction is formed on a top portion of the ceiling portion 2. Further, engagement portions (not shown) to detachably engage with ends of the left side plate portion 3 and the right side plate portion 4 are formed at both sides in the width direction.

Both the left side plate portion 3 and the right side plate portion 4 have the same shapes and function as supports to support the cabinet 1. And the left side plate portion 3 and the right side plate portion 4 are respectively arranged at the left side and the right side of the cabinet 1. Both the left and right side plate portions 3, 4 are made of metal, preferably light metal material such as aluminum or aluminum alloy by extrusion molding.

And each of the left side plate portion 3 and the right side plate portion 4 has a uniform depth over an entire length thereof, such depth corresponding to the depth (thickness) of the liquid crystal display device 10, and has a length longer than a height of the liquid crystal display device 10, such length being regulated corresponding to a height of a portion including an open-and-close panel 16, an open-and-close panel 17 and a common space portion 20 each of which is mentioned later, such portion having the height as same as the height obtained by subtracting the height of the liquid crystal display device 10 from the height of the information terminal device (for example, information terminal device 41 mentioned hereinafter) or the gaming machine (for example, gaming machine 42).

The bottom portion 5 is formed as a stand to install the cabinet 1 on the floor or the predetermined stand, and such bottom portion 5 is made of resin or metal material. This bottom portion 5 has a bottom plate portion 5a which is projected toward the front side of the cabinet 1 and is able to contact with the floor or the stand where the cabinet 1 is arranged, and castors 5b attached to the rear side of the cabinet 1.

The rear panel 6 is arranged between the ceiling portion 2 in the rear side of the cabinet 1 and bottom portion 5, and the rear panel 6 is made of resin or metal material. Here, the rear panel 6 can construct a thin space 35 mentioned later in cooperation with the above mentioned ceiling portion 2, the left side plate portion 3, the right side plate portion 4 and the bottom portion 5. This rear panel 6 has a width corresponding to the width of the ceiling portion 2 and a height slightly shorter than the length of the left side plate portion 3 and the right side plate portion 4. Further, the rear panel 6 is constructed so that the information process device 31 and the power unit 32 (mentioned later), which are commonly utilized in both the information terminal device and the gaming machine to be produced, can be assembled so as not to superimpose in the front-and-rear direction with each other.

And based on the ceiling portion 2, the left side plate portion 3, the right side plate portion 4, the bottom portion 5 and the rear panel 6, the cabinet 1 has the width corresponding to the width of the liquid crystal display device 10, the depth corresponding to the width of the left side plate portion 3 and the right side plate portion 4 and the height corresponding to the length of the left side plate portion 3 and the right side plate portion 4. Thereby, the cabinet 1 constructs the thin space 35 which has a thin depth and a long shape in the height direction. In the thin space 35, the liquid crystal display device 10 and the common space portion 20 can be arranged in order from the upper position, and the information process device 31 and the power unit 32 can be arranged at the lower position of the common space portion 20.

Further, the cabinet 1 has a control panel 15, an open-and-close panel 16 and an open-and-close panel 17.

The control panel 15 is positioned at substantially center position of the cabinet 1 in the height direction thereof and has a width corresponding to the width of the ceiling portion 2. And the control panel 15 has a horizontal base portion, which is projected more frontward than the width of the left side plate portion 3 and the right side plate portion 4, and an operation stick 15a which is freely rotatable within a predetermined angle range and operation buttons 15b which can be pressed are arranged on the base portion. In the control panel 15, a front portion of the base portion is curved so that a center portion in the thickness direction thereof is projected frontward, thereby a curved portion 15c is formed by extrusion molding, similar to the left side plate portion 3 and the right side plate portion 4.

The open-and-close panel 16 is arranged under the control panel 15 and is made of resin or metal material. This open-and-close panel 16 is projected frontward to an extent that a reception space for the information process device 31 arranged in the thin space 35 can be retained, and the open-and-close panel 16 is detachably held between the left side plate portion 3 and the right side plate portion 4. And to the open-and-close panel 16, a coin insertion portion 18 to insert game media such as medals, coins (hereinafter, abbreviated as “coin”) necessary for a game is formed, considering a case that the gaming machine is produced by mainly using the cabinet 1.

And the open-and-close panel 17 is arranged under the open-and-close panel 16 and is made of resin or metal material. This open-and-close panel 17 is projected frontward to an extent similar in a case of the open-and-close panel 16 that a reception space for the power unit 32 arranged in the thin space 35 can be retained, and the open-and-close panel 17 is detachably held between the left side plate portion 3 and the right side plate portion 4.

The common space portion 20 is formed between the liquid crystal display device 10 and the control panel 15. This common space portion 20 is provided in order to assemble devices or constructive elements which are used in only one of the information terminal device and the gaming machine to be produced (for example, in a case of the information terminal device, an issuing device or a card reader mentioned later and in case of the gaming machine, a display panel for displaying payouts and game contents). By forming the common space portion 20, the length of the left side plate portion 3 and the right side plate portion 4 can be set corresponding to the constructive element (s) to be assembled.

In the cabinet 1 constructed according to the above, the left side plate portion 3 and the right side plate portion 4 are formed by extrusion molding, therefore both the left side plate portion 3 and the right side plate portion 4 have measure with uniform and good preciseness over entire length thereof. Thus, each length of the left side plate portion 3 and the right side plate portion 4 can be easily and rapidly regulated corresponding to the height except for the liquid crystal display device 10 in the information terminal device or the gaming machine.

That is, the material (for example, metallic material) to make the left side plate portion 3 and the right side plate portion 4 can be cut with the length corresponding to the height of the information terminal device or the gaming machine, thereby the length of the left side plate portion 3 and the right side plate portion 4 can be set to the measure of the information terminal device or the gaming machine. Therefore, the left side plate portion 3 and the right side plate portion 4 can be produced with the length corresponding to the install place, taking the measure of the information terminal device or the gaming machine to be produced into consideration. Accordingly, the height of the cabinet 1 can be freely set corresponding to demand and use necessary in the install place, as a result, both the information terminal device and the gaming machine can be produced from one cabinet 1. Thus, the cabinet 1 has high general purpose.

Further, the width of the left side plate portion 3 and the right side plate portion 4 has uniform measure over entire length thereof, corresponding to the depth of the liquid crystal display device 10 to be assembled. Thereby, the cabinet 1 has the thickness corresponding to the depth of the liquid crystal display device 10, thus the cabinet 1 is constructed into a thin type construction with narrow depth. And since the width of the ceiling portion 2 corresponds to the width of the liquid crystal display device 10, the width of the cabinet 1 is set to the minimum width. Further, since the liquid crystal display device 10, which is commonly utilizable for both the information terminal device and the gaming machine, is assembled beforehand in the cabinet 1, general purpose of the cabinet 1 can be made high when the information terminal device or the gaming machine is produced.

In addition to the above, since the information process device 31 and the power unit 32, which can be commonly utilized in the information terminal device and the gaming machine, can be assembled on the rear plate 6 so that both the information process device 31 and the power unit 32 are not superimposed in the front-and-rear direction, the information process device 31 and the power unit 32 inevitable for the information terminal device can be assembled in the cabinet 1 so as not to be superimposed with each other in the front-and-rear direction of the cabinet 1. In order realize this construction, the depth of the cabinet 1 is set to larger measure which any one of the information process device 31 and the power unit 32 has, so that thin type construction is spoiled.

Further, the cabinet 1 has the common space portion 20 and the constructive element utilized only in any one of the information terminal device and the gaming machine can be assembled in the common space portion 20, and the length of the left side plate portion 3 and the right side plate portion 4 can be set corresponding to such constructive element. Here, if the size of the constructive element is smaller than the size of the common space portion 20 so that the constructive element is assembled within the common space portion 20, the constructive element utilized in only any one of the information terminal device and the gaming machine can be assembled. Here, if such constructive element has the size projected from the common space portion 20 in the front-and-rear direction thereof, it is enough to attach a protect cover (not shown) so as to cover the projected portion.

As mentioned, the cabinet 1 has degree of freedom of the measure, and especially the cabinet 1 has high degree of freedom to set the height thereof. And since the liquid crystal display device 10, the information process device 31 and the power unit 32, which can be commonly utilized in both the information terminal device and the gaming machine, are assembled in the cabinet 1, thereby both the information terminal device and the gaming machine can be produced, high general purpose of the cabinet 1 is realized at this point. In addition, the thickness of the cabinet 1 corresponds to the thickness of the liquid crystal display device 10, thereby thin type construction is never spoiled.

Further, since the ceiling portion 2 and the bottom portion 5 can be commonly used, production cost of the cabinet 1 can be reduced and term necessary to produce and develop can be shortened. Namely, the cabinet 1 can be easily and rapidly produced.

(Explanation of the Information Terminal Device)

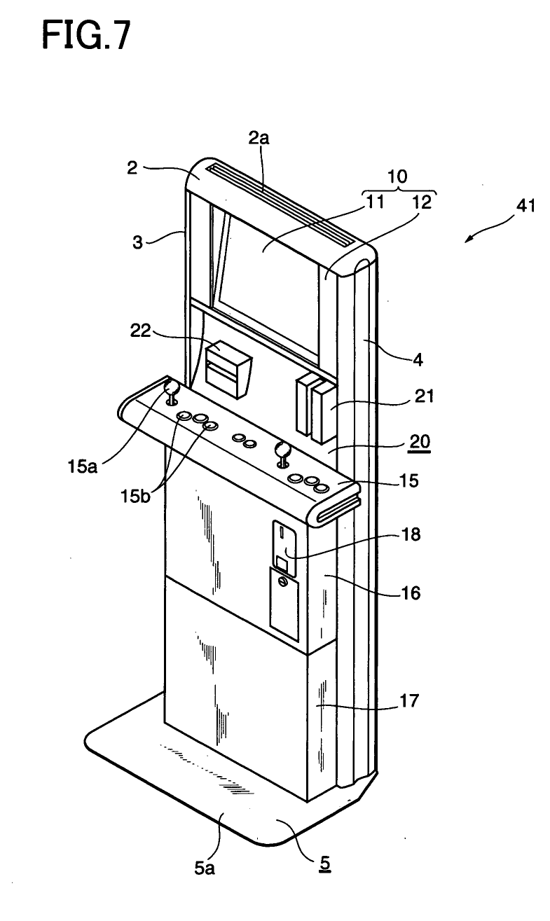

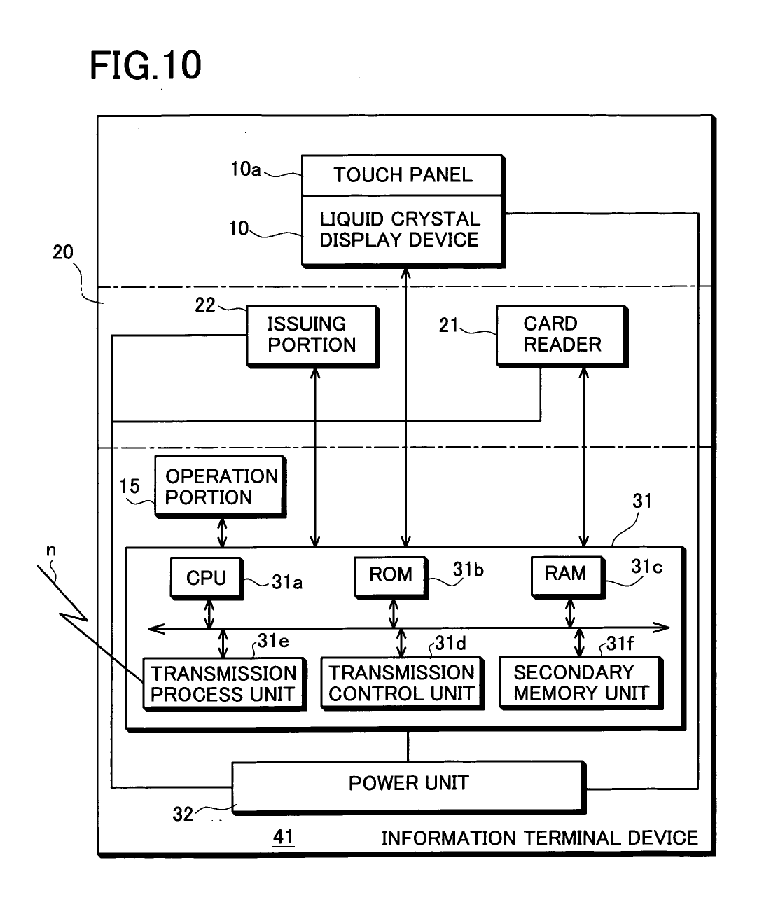

Next, the embodiment utilizing the above constructed cabinet 1 will be described with reference to FIGS. 7 and 10.

FIG. 7 is a perspective view showing an information terminal device 41 utilizing the cabinet 1, and FIG. 10 is a block diagram showing an inner electric construction of the information terminal device 41 utilizing the cabinet 1.

The information terminal device 41 is a device which is installed on the floor of a convenience store and used. This information terminal device 41 is produced by assembling the liquid crystal display device 10, a card reader 21, an issuing device 22, the information process device 31 and the power unit 32 in the above cabinet 1. And each of the above constructive elements is electrically connected as shown in FIG. 10 and image display is conducted on the liquid crystal display device 10 according to control by the information process device 31.

The liquid crystal display device 10 is commonly utilizable in the gaming machine 42 mentioned hereinafter and has a liquid crystal panel 11 and a base body 12 with drive circuits, to which the liquid crystal panel 11 is assembled. This base body 12 is assembled in the thin space 35 of the cabinet 1. In front of the liquid crystal panel 11, a touch panel 10a is arranged. Through the touch panel 10a, information corresponding to the position where a person touches by a finger is input to the information process device 31.

The card reader 21 scans and reads out information stored in a member's card in the convenience store where the information terminal device 41 is installed and inputs the read information to the information process device 31. This card reader 21 is assembled in the common space portion 20 formed in the cabinet 1.

The issuing device 22 is a device (printer) for printing information indicating contents of commodities purchased in the convenience store or reservation contents on a ticket or a receipt, and for outputting the ticket or the receipt therefrom, when a customer purchases commodities or reserves a ticket in the convenience store. This issuing device 22 is also assembled in the common space portion 20 formed in the cabinet 1.

The information process device 31 is commonly utilizable in the gaming machine 42 mentioned later and conducts input and output process of data and control signals among the liquid crystal display device 10, the card reader 21 and the issuing device 22. That is, the information process device 31 is a device (for example, personal computer) to control operation of the information terminal device 41. This information process device 31 is assembled on the rear panel 6 of the cabinet 1 so as not to superimpose with the power unit 32 and is received within the open-and-close panel 16.

The information process device 31 has a CPU (Central Processing Unit) 31a, a ROM (Read Only Memory) 31b and a RAM (Random Access Memory) 31c, and further has a transmission control unit 31d, a transmission process unit 31e and a secondary memory unit 31f.

The CPU 31a operates according to the program stored in the ROM 31b, and conducts input/output of signals with the other elements through I/O ports, thereby the CPU conducts operation control necessary for the information terminal device 41. In the ROM 31b, programs executed by the CPU 31a and permanent data are stored, and in the RAM 31c, data and programs used by the CPU 31a are stored. The transmission control unit 31d operates the transmission process unit 31e according to instructions output from the CPU 31a and the transmission process unit 31e conducts input/output of data with a server (not shown) through a network n. In the secondary memory unit 31f, data base storing information necessary for commodities and issuing tickets is registered.

The power unit 31 is commonly utilizable for the gaming machine mentioned later. And the power unit 31 is assembled on the rear panel 6 of the cabinet 1 so as not to superimpose with the information process device 31 and is received within the open-and-close panel 17. This power unit 31 supplies electric power necessary for operation to the card reader 21, the issuing device 22 and the information process device 31, respectively.

And the above constructed information terminal device 41 is installed on the floor in the convenience store and, for example, is used as follows. In this case, it will be supposed that a predetermined menu image is displayed on the liquid crystal display device 10 of the information terminal device 41.

Here, it will be explained a case that the customer purchases the commodity published in a catalog in the convenience store. At that time, the customer first inspects the catalog and selects the commodity which the customer wants to buy. And the customer operates the control panel 15 or touches the touch panel 10a on the liquid crystal display device 10. Further, the customer selects an item of “purchase of commodities” in the menu image displayed on the liquid crystal display device 10 and inputs a number (commodity code) attached to the commodity which the customer wants to buy. Then, an instruction of “purchase of commodities” is input from the liquid crystal display device 10 and the commodity code specifying the commodity which the customer wants to buy is input to the information process device 31.

On the other hand, in the information process device 31, the CPU 31a accesses the secondary memory unit 3 if and reads out information of the commodity corresponding to the commodity code already input from the data base. Further, the CPU 31a outputs such information to the liquid crystal display device 10, thereby the liquid crystal display device 10 displays such information thereon. Then, the customer can confirm the contents of the commodity (price and number of commodity to be purchased).

Next, the customer inputs predetermined information (customer information) such as his or her name, telephone number and the like. At that time, if the customer has a member's card, such member's card is scanned in the card reader 21 and the customer information is read out. If the customer does not have a member's card, such customer information is input through the menu image displayed on the liquid crystal display device 10. The input customer information is input to the information process device 31.

In addition, in the information process device 31, transaction data (including the commodity code, number of commodity to be purchased and the customer information) in commodity purchase are produced and the CPU 31a instructs the liquid crystal display device 10 so that an image to display the transaction data is displayed thereon. Then, a confirmation image (not shown) of commodity purchase is displayed on the liquid crystal panel 11. In this confirmation image, it is included a button (confirmation button) through which the customer shows his or her intention to purchase the commodity according to contents displayed on the liquid crystal panel 11.

In a case that the customer purchases the commodity according to contents displayed, the customer touches the confirmation button. Information (confirmation information) displaying that input from the confirmation button is done is input to the information process device 31. In the information process device 31, the CPU 31a operates based on input of the confirmation button and instructs the issuing device 22 to issue the ticket. Then, the issuing device 22 issues the ticket of commodity purchase on which information necessary for commodity purchase is printed. The customer shows this ticket of commodity purchase at the entrance of the convenience store and pays money. As mentioned, the customer can purchase the commodity by operating the information terminal device 41.

As mentioned in the above, the information terminal device 41 can be installed in the convenience store. At this point, the information terminal device 41 is a terminal device through which the customer can purchase the commodity. And this information terminal device 41 is produced by using the cabinet 1. Further, the cabinet 1 is produced from the left side plate portion 3 and the right side plate portion 4, both of which are formed by extrusion molding, thereby the length of the left side plate portion 3 and the right side plate portion 4 can be changed according to situation of the convenience store. Therefore, the height of the cabinet 1 can be freely, easily and rapidly regulated, as a result, general purpose of the measure in the height is made high. Thus, the information terminal 41 has high degree of freedom in change of the measure so that, for example, the height thereof can be set to the height of rack existing in the convenience store and the height thereof can be changed between adult person use and children use. And the cabinet 1 is made in thin type, therefore if the information terminal device 41 is installed close to a wall plane of the convenience store, the information terminal device 41 is not so projected from the wall plane, thus install space can be reduced. In addition, production cost of the cabinet 1 is low and the cabinet 1 can be easily and rapidly produced, thus the information terminal device 41 is produced by assembling the information process device 31 and the power unit 32 in the cabinet 1. As a result, cost of the information terminal device 41 can be reduced and produced in a short time.

Here, in the above information terminal device 41, although explanation is done according to the embodiment in which the card reader 21 and the issuing device 22 are assembled therein, the present invention is not limited to the above construction. For example, in addition to the above, an infrared reading unit (this unit is utilized to conduct data transmission with a cellular phone by using infrared rays) may be assembled, or any one of the card reader 21, the issuing device 22 and the infrared reading unit may be assembled. In this case, since the size of the common space portion 20 in the cabinet 1 is determined corresponding the measure of the unit to be assembled, the length of the left side plate portion 3 and the right side plate portion 4 in the cabinet 1 can be set so as to fit for the common space portion 20 determined according to the above.

(Explanation of the Gaming Machine)

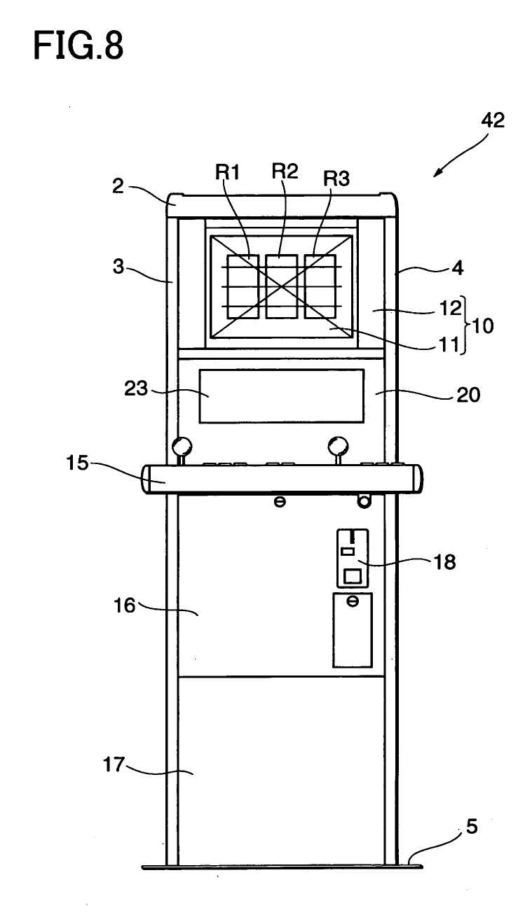

Next, the embodiment of the gaming machine utilizing the above constructed cabinet 1 will be described with reference to FIGS. 8, 9 and 11.

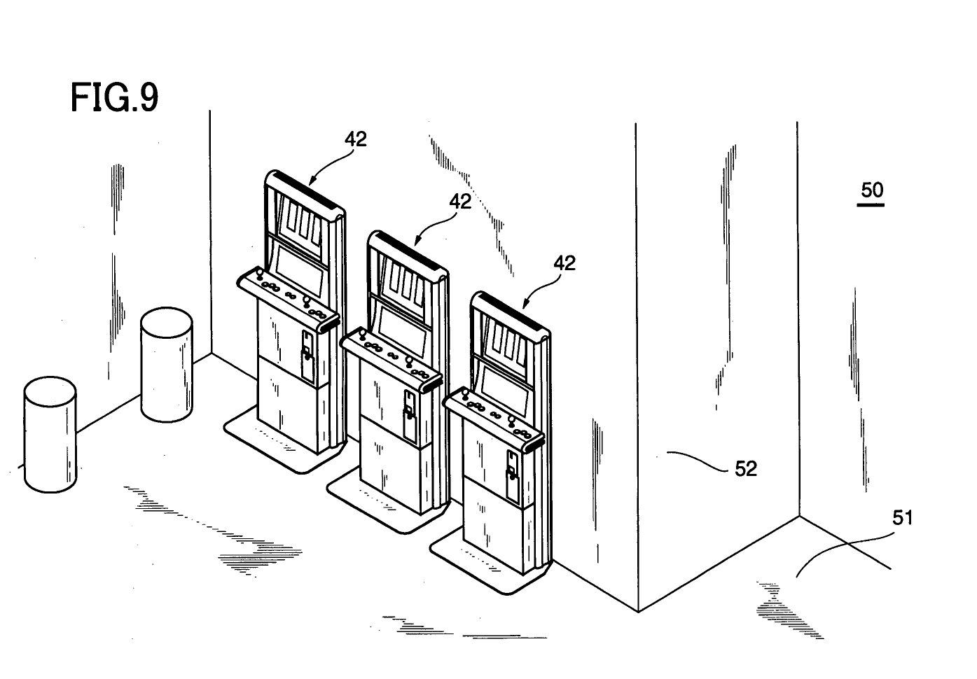

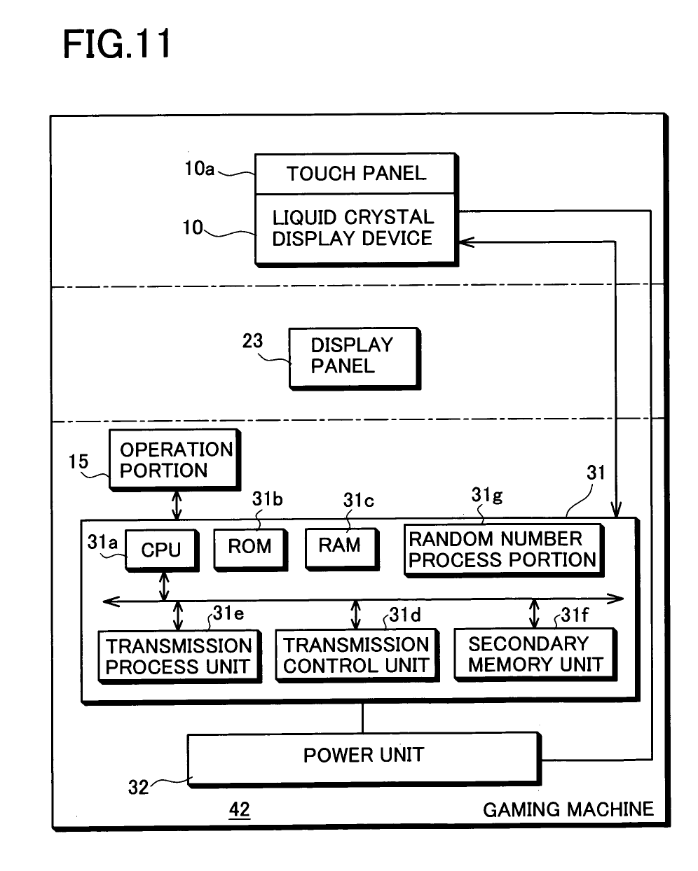

FIG. 8 is a front view showing a gaming machine 42 utilizing the cabinet 1, FIG. 9 is a perspective view showing a state that a plurality of the gaming machines 42 are installed in the game arcade and FIG. 11 is a block diagram showing an inner electric construction of the gaming machine 42.

The gaming machine 42 is a device which is installed on the floor in the game arcade and used (here, a video slot machine is supposed). This gaming machine 42 is produced by assembling the liquid crystal display device 10, a display panel 23 for indicating game contents, the information process device 31 and the power unit 32 in the cabinet 1. Except for the display panel 23, each of the above constructive elements is electrically connected and a slot game is conducted by using a display image of the liquid crystal display device 10 which is controlled by the information process device 31. Among these constructive elements there exist the elements which can be commonly utilized in the information terminal device 41, therefore different points from the information terminal device 41 will be mainly described hereinafter.

The display panel 23 is a panel displaying information such as game contents conducted in the gaming machine 42 and payouts and is assembled in the common space portion 20 in the cabinet 1.

The information process device 31 is different from the information process device 31 in the information terminal device 41 in following points when compared with each other. That is, different points are; the point that the information process device 31 in the gaming machine 42 has a random number process portion 31g; the point that data and programs stored in the ROM 31b, the RAM 31c and the secondary memory unit 31f are different; the point that control contents by the CPU 31a are different; the point that the transmission process portion 31e is not connected to the network n. Here, in the information process device 31 of the gaming machine 42, if the transmission process portion 31e is connected to the network n, thereby it may be realized the gaming machine 42 which can conduct input/output of data with a server (not shown). The random number process portion 31g operates according to instructions by the CPU 31a and generates random numbers within a predetermined range. And the random number process portion 31g voluntarily extracts a random number and inputs such extracted random number to the CPU 31a. Here, the information process device 31 has a clock pulse generator for generating a standard clock pulse to operate the CPU 31a, a frequency divider for inputting a signal obtained by dividing the standard clock pulse with a constant frequency to the CPU 31a. However, in the embodiment, such clock pulse generator and the frequency divider are omitted and not shown.

And the above constructed gaming machines 42 are, for example as shown in FIG. 9, installed on the floor 51 in the game arcade 50 so that the rear panel 6 contacts with a wall plane 52 and used as follows. In this case, variable display images as if reels R1, R2 and R3 each of which has a plurality of symbols are moved are displayed on the liquid crystal display device 10 in the gaming machine 42 (see FIG. 8).

A player who will conduct a game in the gaming machine 42 first inserts a coin to be betted in the coin insertion slot 18 and sets a pay line. Continuously, the player operates the operation stick 15a provided in the control panel 15 and starts the game. Then, the CPU 31a detects insertion of the coin and operation of the operation stick 15a and controls the liquid crystal display device 10 so as to display the variable display images thereon as if each of the reels R1, R2 and R3 are scrolled. At that time, the CPU 31a conducts internal lottery process by using the random number input from the random number process portion 31g.

And when the player operates the operation buttons 15b provided in the control panel 15 while seeing the variable display images displayed on the liquid crystal display device 10, scroll images of each of the reels R1, R2 and R3 is stopped at the operation timing of the operation buttons 15b. Further, based on a symbol combination of the symbols (symbols described on each of the reels R1, R2 and R3) stopped, it is determined whether or not a winning combination is won in the game. If the winning combination is won in the game, a message indicating that the winning combination is won is displayed on the liquid crystal display device 10 and any benefit of the game is given to the player.

As mentioned, the gaming machine 42 can be installed on the floor or the stand in the game arcade and the player can conduct the game by using the gaming machine 42. This gaming machine 42 is produced by using the cabinet 1, similar to the information terminal device 41. And in the cabinet 1, general purpose of the measure in the height is made high. Thus, the gaming machine 42 has high degree of freedom in change of the measure so that, for example, the height thereof can be set corresponding to demand of the install place in the convenience store and the height thereof can be changed between adult person use and children use. And the cabinet 1 is made in thin type, therefore, as shown in FIG. 9, if the gaming machine 42 is installed close to the wall plane 52 of the convenience store, the gaming machine 42 is not so projected from the wall plane 52, thus install space can be reduced. In addition, production cost of the cabinet 1 is low and the cabinet 1 can be easily and rapidly produced, thus the gaming machine 42 is produced by assembling the information process device 31 and the power unit 32 in the cabinet 1. As a result, cost of the gaming machine 42 can be reduced and the gaming machine 42 can be produced in a short time.

1. A cabinet for an information terminal device and a gaming machine, each of the information terminal device and the gaming machine having a liquid crystal display device,
the cabinet comprising:
a ceiling portion disposed on the liquid crystal display device, the ceiling portion having a width corresponding to a width of the liquid crystal display device;
a pair of side plate portions arranged at both sides of the liquid crystal display device, each of the side plate portions having a uniform width corresponding to a depth of the liquid crystal display device and a length longer than a height of the liquid crystal device and regulated corresponding to a height of the information terminal device or the gaming machine except for the liquid crystal display device;
a bottom portion; and
a rear panel with a width corresponding to the width of the ceiling portion, the rear panel being arranged between the ceiling portion and the bottom portion and capable of separately containing an information process device and a power unit both of which are commonly utilizable for the information terminal device and the gaming machine.

2. The cabinet according to claim 1, wherein each of the side plate portions is formed of metal material by extrusion molding.

3. The cabinet according to claim 1, wherein a thin space is formed by the ceiling portion, the bottom portion, the side plate portions and the rear panel, and
wherein the liquid crystal display device utilizable for the information terminal device and the gaming machine is assembled in the thin space.

4. The cabinet according to claim 3, wherein a common space is formed under the liquid crystal display device assembled in the thin space, and
wherein a constructive member characteristic of the information terminal device or the gaming machine is assembled in the common space.

5. The cabinet according to claim 4, further comprising:
a control panel for operating the information terminal device or the gaming machine is provided under the common space.

6. An information terminal device with a cabinet capable of producing an information terminal device having a liquid crystal display device,
wherein the cabinet comprising:
a ceiling portion disposed on the liquid crystal display device, the ceiling portion having a width corresponding to a width of the liquid crystal display device;
a pair of side plate portions arranged at both sides of the liquid crystal display device, each of the side plate portions having a uniform width corresponding to a depth of the liquid crystal display device and a length longer than a height of the liquid crystal device and regulated corresponding to a height of the information terminal device or the gaming machine except for the liquid crystal display device;
a bottom portion; and
a rear panel with a width corresponding to the width of the ceiling portion, the rear panel being arranged between the ceiling portion and the bottom portion and capable of separately containing an information process device and a power unit both of which are utilized in the information terminal device;
wherein a thin space is formed by the ceiling portion, the bottom portion, the side plate portions and the rear panel,
wherein the liquid crystal display device utilized in the information terminal device is assembled in the thin space,
wherein the information process device and the power unit are received on the rear panel, and
wherein electric power is supplied to the liquid crystal display device and the information process device from the power unit and the liquid crystal display device displays images thereon according to control of the information process device.

7. A gaming machine with a cabinet capable of producing a gaming machine having a liquid crystal display device,
wherein the cabinet comprising:
a ceiling portion disposed on the liquid crystal display device, the ceiling portion having a width corresponding to a width of the liquid crystal display device;
a pair of side plate portions arranged at both sides of the liquid crystal display device, each of the side plate portions having a uniform width corresponding to a depth of the liquid crystal display device and a length longer than a height of the liquid crystal device and regulated corresponding to a height of the information terminal device or the gaming machine except for the liquid crystal display device;
a bottom portion; and
a rear panel with a width corresponding to the width of the ceiling portion, the rear panel being arranged between the ceiling portion and the bottom portion and capable of separately containing an information process device and a power unit both of which are utilized in the gaming machine;
wherein a thin space is formed by the ceiling portion, the bottom portion, the side plate portions and the rear panel,
wherein the liquid crystal display device utilized in the gaming machine is assembled in the thin space,
wherein the information process device and the power unit are received on the rear panel, and
wherein electric power is supplied to the information process device and the liquid crystal display device from the power unit and a game is conducted by using images displayed on the liquid crystal display device which is controlled through the information process device.
